(19) United States
(12) Patent Application Publication
(10) Pub. No.: US 2003/0055826 A1
(43) Pub. Date: Mar. 20, 2003

(54) System and method for connecting to and controlling to disparate databases

(76) Inventor: Kevin Graham, Austin, TX (US)

Correspondence Address: Erik B. Cherdak & Associates, LLC, Suite 906, 11300 Rockville Pike, Rockville, MD, 20852, US

(21) Appl. No.: 09/951,889

(22) Filed: Sep. 14, 2001

(51) Int. Cl. G06F 17/30; G06F 15/16

(52) U.S. Cl. 707/10; 709/246

(57) ABSTRACT

Systems and methods for facilitating communications with and control of disparate databases via an electronic data network, such as the Internet and WWW. The systems and methods include a database interface system for interfacing client applications to a database. The database interface system includes a data source driver and an interface facility. The data source driver is related to the database and is configured to allow operative access to the database via an electronic data network. The interface facility is coupled to the electronic data network and is configured to accept a message from a client coupled to an electronic data network and configured to send and receive messages containing a character sting (e.g., a request for data, etc.) to access the database via the database source driver based on the character string within the message, to perform a database operation in the database based on the character string, and to return a message to the client corresponding to the executed database operation.

### BACKGROUND OF THE INVENTION

1. Field of the Invention

The present invention relates to systems and methods used to connect to and control databases. More particularly, the present invention relates to systems and methods used to interface multiple application clients with multiple disparate databases via a single, extensible interface.

2. Description of the Related Art

Databases are well known. Application interfaces to databases are also well known. And in the past decade, the use of databases world-wide has grown immensely. In fact, today databases are applied to help organize data or solve problems related to virtually every aspect of life, from personal organization to corporate enterprise applications.

Recently, the world has seen an intense technology growth, and especially in the last few years. Advances in microchip technology has made computers faster and more powerful than ever imaginable. Advances in memory allocation, storage, and disk technologies have also been realized. Accordingly, databases have become more powerful and robust, and can now maintain incredibly huge amounts of data. Improvements to databases not only include size and speed, but the way that data is related, connected and used. Such advances in database technologies has helped change the computing landscape world-wide.

One way that the database improvements has changed the computing landscape is that companies, governments, individuals, etc. collect and store more and more data in databases each year. Data that has typically been stored in paper files are being converted and entered into databases. And, as more and more data is stored and shared, there is a trend to centralizing the data into a centralized database, thus making enormous amounts of data accessible and intelligent. For example, a manufacturer may store manufacturing, maintenance, and engineering data (which had previously been stored separately) in a single database, and tie the data together intelligently by their natural relationships to make the data more usable, improve manufacturing efficiencies, improve maintenance and engineering support, etc.

Another recent advance that has changed the face of computing is the popular use of the Internet and World Wide Web, especially the addition of e-business applications (e.g., B2B, e-commerce, etc.). The Internet, by its very nature, makes it possible to share information between companies, with the public, etc. that has been previously unavailable.

One way that the Internet has changed the landscape of computing is the way that data is shared and distributed. Distributed data, across companies and network may be accessed from one location via a simple web browser. Accordingly, more and more companies are tying their core business systems to the Internet. And, whole industries have sprung up to support Internet commerce.

Another way that the Internet has changed modern computing has to do with computing architecture. Since the advantage of the Internet lies in its ability to distribute content, data, etc. and provide access to the same via a web browser, computer architectures have grown and changed accordingly. For instance, applications are distributed via the Internet and accessible through web browsers. Technologies such as JAVA are ideal for such web computing, allowing application interfaces to be downloaded and executing in a web browser. And, distributed computing provides a means that is extendible (i.e., modules may be added and replaced without changing the entire application or architecture).

The way that data is collected, generated, maintained and shared has recently changed to mirror the advances in web computing and distributed architectures. For example, data may be distributed across networks to improve web application performance. Or, data may be collected by one company to be shared by several other companies via the Internet and WWW. Therefore, the present state of computing includes a variety of distributed, centralized or stand-alone databases being interfaced to a combination of stand-alone, legacy, and distributed computer applications. For example, a telecommunications company may have a database that maintains customer account data and a database that maintains switch data. The customer account data may be accessible to the public via a web site application interface (e.g., an HTML page, JAVA Applet, etc.) while the switch database may be a back-office system only accessible via a legacy computer application. This same company may want to share its back-office data with customers, other companies, etc., via the Internet and WWW.

There are problems interfacing separate databases with distributed computer applications, such as web applications. One problem is version control. Database or application upgrades may occur separately and in the case of extendible, modular applications, many be updated piecemeal (i.e., modules at a time, etc.). As changes or upgrades occur, computer interfaces may become out of synch with databases because of their versions. For example, an interface form of a older version may not be able to access a database package in a newer database.

Another problem that occurs is related to database drivers. Database manufacturers and third party providers make and distribute database drivers that provide access to a database engine. For example, Oracle 8i is shipped standard with SQLnet, which provides operative access to the Oracle 8i database from Oracle Forms, Reports and Menus products over a network. Similarly, Oracle manufactures and distributes a JDBC driver for accessing an Oracle database from a JAVA program. However, to access a database, one must usually know what driver to use and that driver must be available to the particular program used to access the database (e.g., a driver is loaded on a local machine or one the network). Often, a reference to the driver must be hard coded within the application. For example, when using a program such as Microsoft Access to access an Oracle database, a programmer manually selects the appropriate driver from within Access and manually connects to the database.

Additionally, if an application interface is accessing several different databases, then it may be required to use a different database drive to access each separate database. Typically, an application interface uses a default driver or makes a call outside the program that will use a particular driver that is loaded on the same machine that the application interface is loaded. Problems occur when updates are made to versions of application software or databases that require updates to database drivers. Or, if a module is added that requires access to a new database, that module may require a driver that is not yet loaded. Connecting to many different kinds of database may, thus, become confusing.

Thus, there exists a need to provide new and improved systems and methods for interfacing distributed computer applications to multiple disparate databases. Such systems and methods should utilized object oriented programming and be extendible and distributable. Applications should not need to know what kind of database it is connecting to. And, databases should be able to be updated without updating or upgraded the applications.

The present invention squarely addresses the aforementioned problems and delivers such new and improved systems and methods, which are described in detail below.

### SUMMARY OF THE INVENTION

The present invention solves the aforementioned problems and provides new and improved systems and methods for connecting to and controlling disparate databases.

The systems and methods include a database interface system for interfacing client applications to a database. The database interface system includes a data source driver and an interface facility. The data source driver is related to the database and is configured to allow operative access to the database via an electronic data network. The interface facility is coupled to the electronic data network and is configured to accept a message from a client coupled to an electronic data network and configured to send and receive messages containing a character sting (e.g., a request for data, etc.) to access the database via the database source driver based on the character string within the message, to perform a database operation in the database based on the character string, and to return a message to the client corresponding to the executed database operation.

According to another embodiment of the present invention, provided is a database interface system for interfacing client applications to a plurality of databases including a client, a database interface facility, a statement interpreter, and a results interpreter. The client is coupled to an electronic data network and configured to send and receive messages and to request a database operation. The database interface facility is configured to receive the request from the client via the electronic data network, to assign a transaction proxy to the client based on the request, to send and receive messages via the electronic data network. The transaction proxy is configured to send and receive messages via the electronic data network, and to connect to at least one database of the plurality of databases and perform a database operation and receive a result from the database. The statement interpreter is configured to receive the request from the transaction proxy, to convert the request into at least one valid database command based on the request, and to return the converted message to the transaction proxy. And, the results interpreter is configured to receive the result from the transaction proxy, to convert the result based on the request and the client, and to return the converted result to the transaction proxy.

And, according to another embodiment of the present invention, provided is a method for accessing a disparate database and performing a database operation comprising the steps of: at a client, passing a database operation request to a database interface facility; at the database interface facility, receiving the request and converting the request into at least one valid database command based on the client and the request; at the database interface facility, access a database based on the request and the client, an executing said at least on valid database command; at the database interface facility, capturing results generated by the database based on said at least one executed database command; at the database interface facility, converting the results to a usable message based on the request and the client; and, at the database interface facility, returning the usable message to the client.

### BRIEF DESCRIPTION OF THE DRAWING FIGURES

The present invention is described in detail below with reference to the attached drawing figures, of which:

FIG. 1 is a block diagram of a system in which a database interface is used to facilitate database communications and operations between disparate clients and disparate databases via an electronic data network in accordance with a preferred embodiment of the present invention;

FIG. 2 is a detailed logical diagram of the system of FIG. 1 and, in particular, the database interface facility shown therein.

FIG. 3 is a block diagram of a data processing system that facilitates the structures in FIGS. 1 and 2, in accordance with a preferred embodiment of the present invention;

FIGS. 4A thru 4D are a flow chart of method that facilitates database communications and operations within a in accordance with a preferred embodiment of the present invention.

### DETAILED DESCRIPTION OF THE PREFERRED EMBODIMENTS

The present invention is now discussed in detail with regard to the attached drawing figures, which were briefly described above. Unless otherwise indicated, like parts and processes are referred to with like reference numerals.

For the purposes of the following discussions, the following terms are intended to have the following means:

A daemon is a computer program, module or the like, and may be an object in an object oriented framework, a JAVA servant, servlet, program, a C++ program, etc.

A servant is a modular piece of code, which runs within an application server system framework. For example, a servant may be an object in an object oriented framework, a JAVA servant, servlet, program, etc.

A facility is a system component (e.g., program, server system, service, daemon, etc.) that may be hardware, software or a combination thereof.

### Structural Aspects of the Present Invention

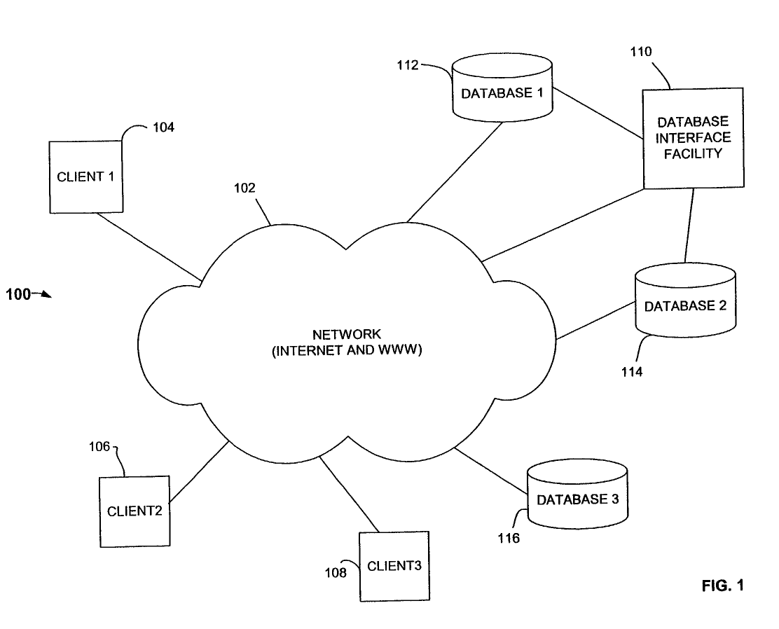

Referring now to FIG. 1, depicted therein is a block diagram of a system that facilitates communication and control between distributed computer applications and disparate databases via a electronic data network. In particular, system 100 includes several clients, client1 104, client2 106 and client3 108 coupled to a network, such as the Internet and WWW 102. Also included are several databases, database1 112, database2 114 and database3 116 also coupled and connected to network 102. Finally, system 100 includes a database interface facility 110 that is coupled to network 102. Also shown in FIG. 1, direct connections exist between database1 112 and database interface facility 110, and also between database2 114 and database interface facility 110.

Clients 104, 106 and 108 may be any computer program, sub-program, application or module that is configured to send and receive messages via network 102. Clients 104, 106 and 108 may be distributed across network 102 or alternatively, may be loaded and executed on the same computer processing arrangement (e.g., servers, etc.). For example, a distributed modular web application may include a JAVA Applet that is downloaded and executed within a web browser. That JAVA Applet may communicate with a JAVA program, object, etc. located anywhere on network 102 via JAVA RMI, IP, etc. JAVA is a registered Trademark of SUN MICROSYSTEMS CORPORATION. An exemplary distributed application architecture in which the present invention may facilitate database communications and control is disclosed in co-owned, co-pending U.S. patent application No. “09/______”, entitled “MODULAR, EXTENSIBLE APPLICATION SERVER THAT IS DISTRIBUTED ACROSS AN ELECTRONIC DATA NETWORK AND METHOD OF MAKING SAME,” filed on ______, 2000, and is hereby incorporated by reference.

Databases 112, 114, and 116 may include any well known database engine running on a conventional database server connected to network 102, such as an ORACLE 8i database manufactured and marketed by the ORACLE CORPORATION executing on and served by a properly outfitted and configured HEWLETT PACKARD L Class Server connected to the Internet and WWW and running an HP-UX operating system. One having ordinary skill in the art will readily understand such database structures. Databases 112, 114, and 116 are preferably relational, but may be object oriented.

Database interface facility 110 is a computer program interface coupled to network 102 and configured to send and receive messages via network 102 (e.g., via JAVA RMI, IP, etc.), to access database 112, 114, and 116 via network 102 or via a direct connection, to perform a database operation within database 112, 114, and 116, to receive results from database 112, 114, and 116 based on the operation performed. Database interface facility 110 is further configured to receive a request for a database operation from clients 104, 106 and 108, convert the request into valid database commands, such as a SQL statements, based on the request and/or the client. Database interface facility 110 is also configured to determine which database to access based on the request and/or the client. Accordingly, database interface facility 110 may also include or have access to additionally disk, memory or database facilities and may be configured to access files, disk or other database facilities in order convert requests, interpret results and determine what databases to access.

Also, debases 112 and 114 are shown with direct connections with database facility 110; this is meant to represent that the databases may be linked via a private network, VPN or other network, or alternatively may reside on the same server arrangement as the database facility 110.

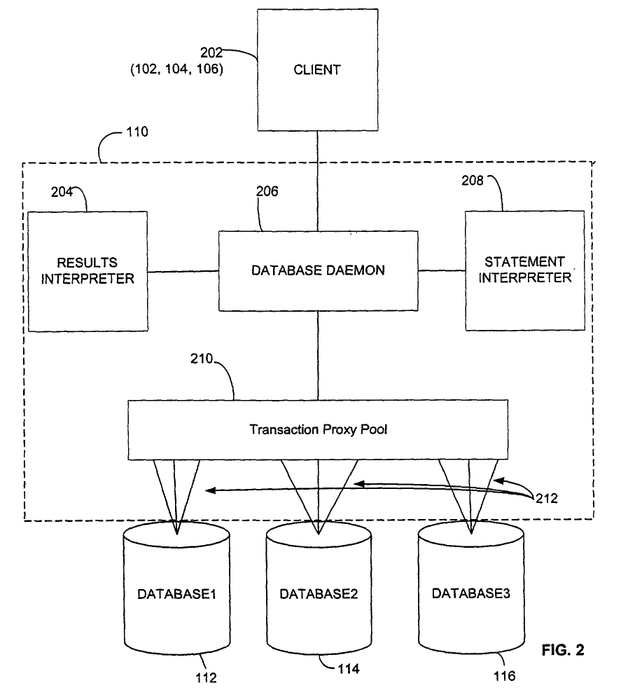

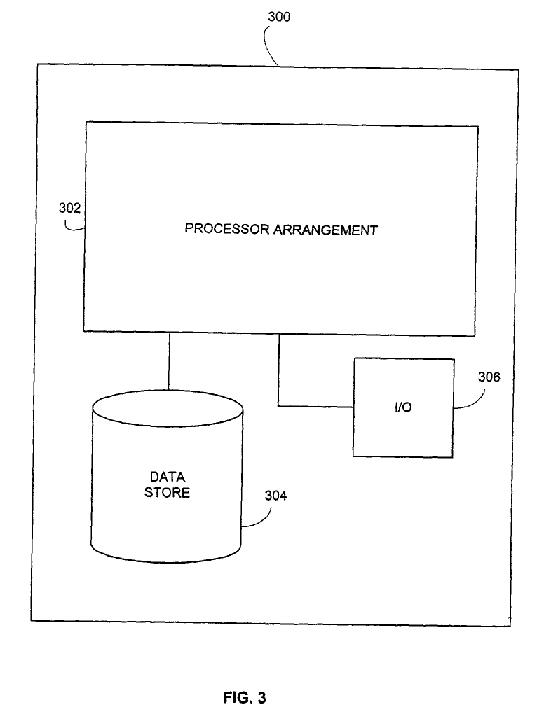

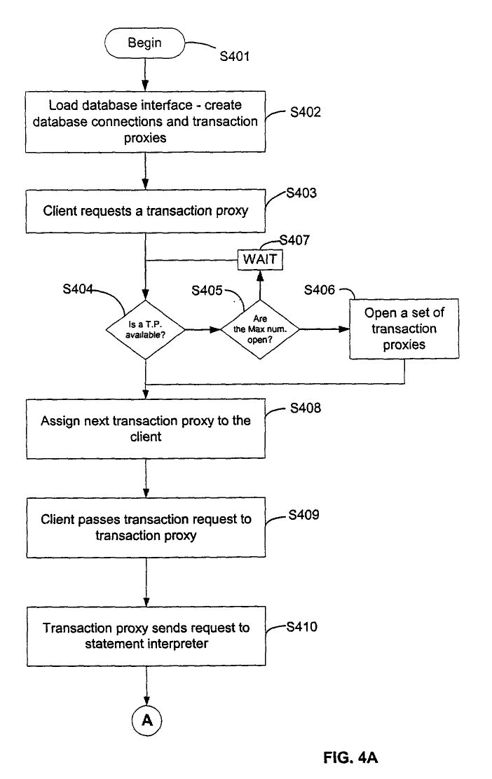

Referring now to FIG. 2, depicted therein is a detailed logical diagram of a database interface facility 110 interfacing a single client with and facilitating communications and control of several databases within system 100. In particular, subsystem 200 includes a client 202 (such as one of clients 104, 106, 108), results interpreter 204, database daemon 206, statement interpreter 208, transaction proxy pool 210, and databases 112, 114, and 116. The dotted box around results interpreter 204, database daemon 206, statement interpreter 208, and transaction proxy pool 210 represent database interface facility 110.

Database daemon 206 is the “brain” of database interface facility 110. Database daemon 206 may be any program, sub-program or module (e.g., JAVA servant, program, C++ program, etc.) that is configured to register client 202 and assign client 202 a transaction proxy from transaction proxy pool 210, to maintain transaction proxy pool 210, to add and delete transaction proxies from transaction proxy pool 210, and to send and receive messages, such as to results interpreter 204, statement interpreter 208, and transaction proxy pool 210 (i.e., via JAVA RMI, TCP/IP, etc.). In one embodiment of the present invention, database daemon 206 is a JAVA servant configured to register client 202 and all transaction proxies within transaction pool 210, to reference client 202 to a transaction proxy within transaction pool 210, to initiate a transaction object to pass to the transaction proxy, to create and terminate leases, and to assign the reference a lease. The registration of JAVA objects and the use of leases to manage the same within a JAVA application framework is explained in co-owned, co-pending U.S. patent application No. “09/______”, entitled “A REMOTE CLIENT MANAGER THAT FACILITATES AN EXTENDIBLE, MODULAR APPLICATION SERVER SYSTEM DISTRIBUTED VIA AN ELECTRONIC DATA NETWORK AND METHOD OF MAKING SAME,” filed on ______, 2000, and is hereby incorporated by reference.

Results interpreter 204 may be any program, sub-program, object, etc. that is configured to receive a message containing formatted results from a data operation from a transaction proxy within transaction proxy pool 210, or directly from database daemon 206, to convert the results into usable formatted data based client 202 and the database operation, and return the usable formatted data to the sender. A transaction object, for example, may be used to pass information between each component within sub-system 200. Such message or communication could be made via typical programming protocols and calls, such as via JAVA RMI, IP, etc., and should contain enough information in order to perform the conversion. For example, the database results are intended to be returned to a client that is going to use the results in some way. Therefore, based on the client, a format may be specified and passed within the message. Or, alternative, data may be stored related to the client, such as the client ID, name, IP address, etc., or the same may be passed to results interpreter 204 along with the set of results.

Statement interpreter 208 may be any program, sub-program, object, etc. that is configured to receive a message containing a request for a database operation (e.g., a query, an update, an insert, a deletion, a batch process, a PL/SQL package or routine, etc.) from a transaction proxy within transaction proxy pool 210, or directly from database daemon 206, to convert the results into a valid database operation (i.e., a valid SQL statement, for example) based on client 202 making the request, the request, the transaction proxy, and/or the database to be accessed. For example, the request is intended to be a request for a database operation within a database, originating from client 202, which may be part of a distributed application, and client 202 either wants to query, add, delete or update data. Furthermore, the client may want to add, delete or update data via a batch process, PL/SQL package, etc. Based on the database that is to be updated and the driver to access the same, syntax may vary. Therefore, the statement interpreter should be passed enough information to convert the request into a statement that is syntactically correct. Therefore, a message containing the client ID, name, IP address, database name, instance, version, transaction proxy ID, etc. may be passed to statement interpreter 208.

Transaction pool 210 represents transaction proxies that are pooled objects by database daemon 206. A transaction proxy is a program, sub-program, object, etc. that may be referenced to client 202 and is configured to maintain a connection (i.e., a session) to a database from databases 112 to 116, to perform database operations, to capture results including errors, to compile database objects, etc. Connections are shown in FIG. 2 as connections 212. A transaction proxy may be a JAVA object that operates as a wrapper for a JDBC driver, for example. Within transaction pool 210, there may be a number of transaction proxies connected to each database. Accordingly, a minimum and maximum number of active transaction proxies within transaction proxy pool 210 may be set by database daemon 206 as required. For example, transaction proxies may be limited to improve server speed, or minimums may be set to improve connection speed and application (i.e., client) speed and responsiveness. Also, transaction proxies may be created based on the database it will be connected to, the client it will be referenced to, or both. Accordingly, transaction proxies may be pre-configured or configured dynamically at runtime.

If client connections or references are dropped, the associated transaction proxies may maintain their database connections and sessions, continue their processes, complete their transaction, or terminate their connections, sessions and transactions based upon design requirements.

The structures shown in FIGS. 1 and 2 are shown as distributed across a network, such as the Internet and WWW. However, the present invention is not so limited. For example, clients may reside on the same server system as the data databases or database interface facility. One having ordinary skill in the art will readily understand that the present invention may include a number of embodiments by varying the architecture of the same. Furthermore, it will be readily understood that the structures that comprise database interface facility 110 are represented logically; however, such structures and components may be combined or varied dependency on design requirements.

Referring now to FIG. 3, depicted therein is a block diagram of a computing system which may be used to implement database facilities, client facilities, network facilities and database interface facilities, to execute programs, API's, applets, utilities and other system components, etc. as described above with regard to FIGS. 1 and 2 in accordance with a preferred embodiment of the present invention. In particular, FIG. 3 depicts a data processing system DP which further includes a processor arrangement 302 including one or more processing elements, a data storage subsystem 304, an IO facility 306. The arrangement of these structures shown with data processing system DP will be immediately understood by those skilled in the art.

Data processing system DP is configured to receive and transmit data to and from network facilities and devices, customer systems, vendor systems, etc. via protocols such as TCP/IP, HTTP, JAVA RMI, etc., execute compilers, runtime engines, API's, operating systems, editors, database drivers and web server systems necessary to facilitate the present invention.

Data storage subsystem 304 as shown within data processing system DP, will include database objects, tables, columns, extents, etc. necessary to facilitate the present invention. Accordingly, data storage subsystem 304 may be configured to store data in files, flash memory, etc.

### Operational Aspects of the Present Invention

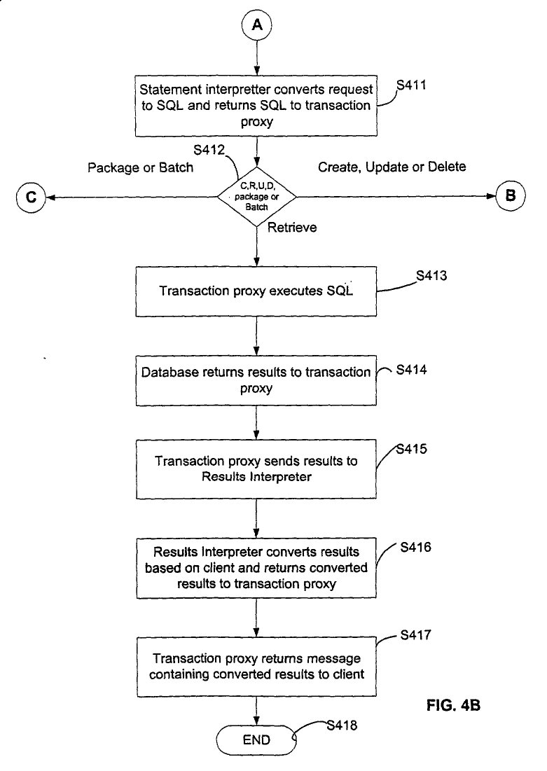

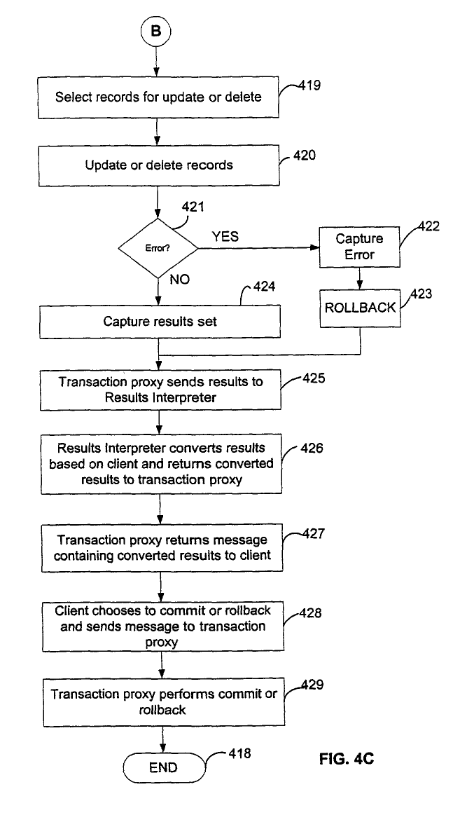

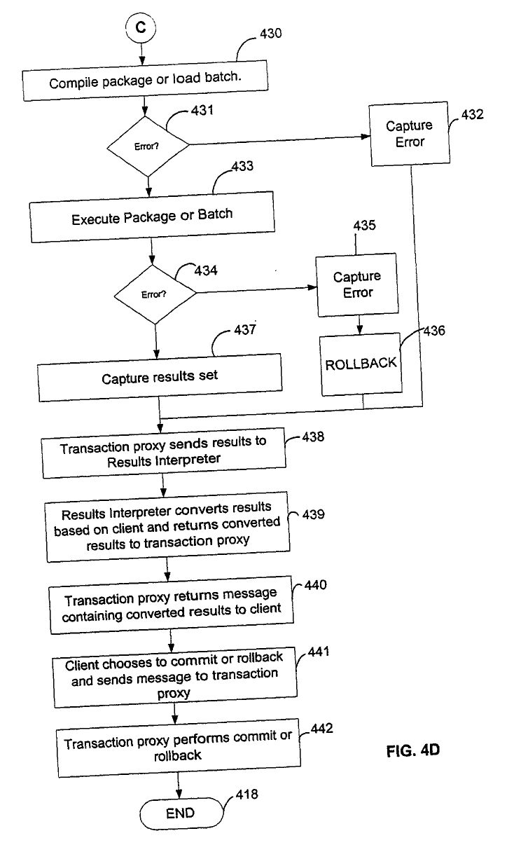

Referring now to FIG. 4A, depicted therein is a flow chart of a method that facilitates database communications and operations between disparate clients and disparate databases in accordance with a preferred embodiment of the present invention. In particular, processing begins at step S401 and immediately proceeds to step S402.

At step S402, a database interface is loaded and the database connections and transaction proxies are created. As described above with reference to FIGS. 1 and 2, the database interface may be a JAVA program running on a separate server machine as the databases and configured to make connections and communicate to other program units such as database interface facility 110 shown and described with reference to FIGS. 1 and 2. According to a preferred embodiment of the present invention, a minimum number of database connections are created, and transaction proxies are created associated to each connection. Transaction proxies have already described above with reference to FIGS. 1 and 2.

Next, at step S403, a client requests a transaction proxy from the database interface. As already described above, a client may be a JAVA servant within an application running on an application server, an applet running within a web browser, or any other program or sub-program configured to request database operations via according to an embodiment of the present invention such as clients 104, 106, and 108. The client may communicate to the database interface via JAVA RMI or other standard protocols as already described above.

Next, at step S404, the database interface checks to see if any transaction proxies are currently available. If a transaction proxy is not available (i.e., they are all referenced to other clients), then processing proceeds to step S405, where database interface checks if the maximum number of transaction proxies are running. As already described above, according to a preferred embodiment, a maximum number of transaction proxies is set. If this number is already met, then processing proceeds to step S407, where the client will wait for a transaction proxy to become available. For example, a lease may expire or a client may return a transaction proxy to the pool. Processing returns to step S404 after a wait period. Otherwise, if the maximum number of proxies has not been met, at step S406, another set of transaction proxies are started.

At step S408, an available transaction proxy is assigned, (referenced) to the client. The assignment is made based upon the client and the request, and may be made as already described above with reference to FIGS. 1 and 2. Then, next, at step S409, the client passes a database request to the transaction proxy. The request may be in any format and request any database operation. According to a preferred embodiment, the request may be a transaction object (or a message, file, etc.) that is passed via JAVA RMI, but may be made via a variety of protocols. Processing proceeds to step S410. At step S410, the transaction proxy passes the request (object, message, file, etc.) to a statement interpreter. As already described above, there may be a statement interpreter for each database connection, type of database, type of client, etc. Processing proceeds to off-page reference A.

Referring now to FIG. 4B, next at step S411, The statement interpreter converts the request into a valid SQL statement and returns the statement to the transaction proxy. Next, at step S412 processing is separated based on the type of database transaction requested. If a query (retrieve) is requested, processing proceeds to step S413; if a batch process or package is requested, processing proceeds to off page reference B; and, if a create, update or delete is requested, off page reference C.

At step S413, transaction proxy executes the SQL query (i.e., the statement returned from the interpreter). As already described above, the transaction proxy is connected to the database and communicates with the database via JDBC, SQLNet, etc.

Next, at step S414, the database returns a result to the transaction proxy (i.e., via normal database operations, via JDBC, etc.). And, at step S415, the result is sent to a results interpreter by the transaction proxy. And, at step S416, the results interpreter converts the result into the proper format, as already described above with reference to FIGS. 1 and 2, based upon the client, the request, etc. and returns the converted results to the transaction proxy. And, at step S417, the transaction proxy returns the converted result to the client. And processing terminates for the query at step S418.

Referring now to FIG. 4C, processing from step S4-11 proceeds to step S419. At step S419, the SQL statement returned by the statement interpreter is an update or a delete. According to a preferred embodiment of the present invention, a SQL query may be performed ahead of time to select the set of records to be updated or deleted. Next, at step S420, the update, insert or delete is executed.

Next, at step S421, if an error occurs, processing proceeds to step S422, otherwise processing proceeds to step S424. At step S424, the error is captured and then at step S423, a rollback is performed and processing proceeds to step S425. At step S424, the results are captured and processing proceeds to step S425.

At step S425, the captured results (or error) are sent to the results (or error) interpreter by the transaction proxy. Then, at step S426, the results interpreter converts the results into the proper format, as already described above with reference to FIGS. 1 and 2, based upon the client, the request, etc. and returns the converted results to the transaction proxy. Processing proceeds next to step S427, where the converted results are sent to the client. The client may be given the option to commit or rollback the results (if an operation was performed; i.e., no error) at step S428, such as via an interactive message. Then, at step S429, the transaction performs the commit or rollback. Processing terminates for an update or delete at step S4-18.

Referring now to FIG. 4D, processing from FIG. 4B, step S412 proceeds to step S430. The request is for a batch process or a package. At step S430, a PL/SQL package, batch process, or other program related to the request is compiled. For example, a PL/SQL package may be passed with the request, a file containing a list of records to be updated, deleted, etc. may be passed, or a reference (i.e., name, location, etc.) to the same may be passed, etc.

Next, at step S431, if the package or batch process does not compile and/or there is an error, processing proceeds to step S432 where the error is captured. Processing from step S432 proceeds, directly to step S438. If there is no error, processing proceeds to step S433 where the package is executed. Next, at step S434, if an error occurs in the execution of the package or batch, then processing proceeds to step S435 where the error is captured, then to step S436 where a rollback is performed. As already described above with reference to FIGS. 1 and 2, the exact record that errored may be captured, or alternatively, a general message may be returned, etc. Processing proceeds next to step S438.

At step S438, the transaction proxy sends the results (results set, results message, errors, etc.) to the results interpreter. Next, at step S439, the results interpreter converts the result into the proper format, as already described above with reference to FIGS. 1 and 2, based upon the client, the request, etc. and returns the converted results to the transaction proxy.

Next at step S440, the converted results are sent to the client. The client may be given the option to commit or rollback the results (if an operation was performed; i.e., no error) at step S441. Then, at step S442, the transaction performs the commit or rollback.

Processing terminates at step S418.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

For example, one having ordinary skill in the art will understand that the present invention may be designed to be more or less interactive depending upon design requirements. Additionally, interpreters may be designed to handle additionally database types and database driver types, or alternatively, interpreters may be added to the present invention to facilitate communication and control of additional disparate databases.

What is claimed is:

1. A database interface system for interfacing client applications to a database via an electronic data network, comprising:
a data source driver corresponding to said database that is configured to allow operative access to said database;
an database interface facility coupled to said electronic data network and configured to accept a request message from a client containing a character string, to access said database via said database source driver based on said character string, to perform a database operation in said database based on said string, and to return a results message to said client based on said database operation, said client configured to send and to receive messages via said electronic data network.

3. The system according to claim 1, wherein said data source drive comprises a database driver compatible with said database.

4. The system according to claim 1, wherein said client and said database interface facility are JAVA programs and said messages are sent via JAVA RMI.

5. The system according to claim 1, wherein said data source drive contains a JDBC driver.

6. The system according to claim 1, wherein database interface facility generates a SQL statement based on said character string and said client.

7. The system according to claim 1, wherein said database interface facility maintains a constant connection to said database via said data source driver.

8. The system according to claim 1, wherein said character string includes a request for data from said database.

9. The system according to claim 1, wherein said character string includes a request for a batch update to said database.

10. The system according to claim 1, wherein said character string includes a request for a batch update to said database.

11. The system according to claim 1, wherein said results message includes an error returned from said database.

12. The system according to claim 1, wherein said results message includes the number of rows returned from said database.

12. A database interface system for interfacing client applications to a plurality of databases comprising:
a client coupled to an electronic data network and configured to send and receive messages and to request a database operation;
a database interface facility configured to receive said request from said client via said electronic data network, to assign a transaction proxy to said client based on said request, to send and receive messages via said electronic data network, said transaction proxy being configured to receive send and receive messages via said electronic data network, and to connect to at least one database of said plurality of databases and perform a database operation and receive a result from said database;
a statement interpreter configured to receive said request from said transaction proxy, to convert said request into at least one valid database command based on said request, and to return said converted message to said transaction proxy; and
a results interpreter configured to receive said result from said transaction proxy, to convert said result based on said request and said client, and to return said converted result to said transaction proxy.

13. The system according to claim 12, wherein said client, said database interface facility, said statement interpreter, and said results interpreter are JAVA programs and said messages are sent via JAVA RMI.

14. The system according to claim 12, wherein said transaction proxy use at least one JDBC driver.

15. The system according to claim 12, wherein said database interface facility is further configured to create and terminate additional transaction proxies as requests are made by said client.

16. The system according to claim 12, wherein said transaction proxy maintains a constant connection to said database.

17. The system according to claim 12, wherein said valid database command is SQL.

18. The system according to claim 12, wherein said result contains an error.

19. The system according to claim 12, wherein said result contains rows of data.

20. The system according to claim 12, wherein said statement interpreter is further configured to access a second database in order to convert said request into at least one valid database command.

21. The system according to claim 12, wherein said results interpreter is further configured to access a second database in order to convert said result into a formatted results message corresponding to a format relating to said client.

22. A method for accessing a disparate database and performing a database operation comprising the steps of:
at a client, making a database operation request and passing it to a database interface facility;
at said database interface facility, receiving said request and converting said request into at least one valid database command based on said client and said request;
at said database interface facility, access a database based on said request and said client, and executing said at least on valid database command;
at said database interface facility, capturing results from said database based on said at least one executed database command;
at said database interface facility, converting said results to a formatted message based on said request and said client;
at said database interface facility, returning said formatted message to said client.

23. The method according to claim 22, wherein said client and said database interface facility are JAVA programs and said messages are sent via JAVA RMI.

24. The method according to claim 22, wherein said database interface facility maintains a constant connection to said database.

25. The method according to claim 22, wherein said database interface facility is converts said request based on the IP address of said client.

26. The method according to claim 22, wherein said database interface facility accesses a second database to perform said conversions.

27. The method according to claim 22, wherein said at least one valid database command is a SQL statement.

28. The method according to claim 22, wherein said results contains an error.

29. The method according to claim 22 wherein said request is a request to update data in said database, further comprising the step of: at said database interface facility, committing said update after executing said at least one valid database command.

30. The method according to claim 22, wherein said database interface facility is further configured to perform a batch process based on said request.
